(19) United States
(12) Patent Application Publication
(10) Pub. No.: US 2025/0350644 A1
(43) Pub. Date: Nov. 13, 2025

(54) METHOD, APPARATUS, SYSTEM AND COMPUTER PROGRAM FOR SECURITY PROCESSING OF MULTI-AGENT SYSTEM

(71) Applicant: SAMSUNG SDS CO., LTD., Seoul (KR)

(72) Inventors: Jieun LEE, Seoul (KR); Yoonchan JHI, Seoul (KR); Jihoon CHO, Seoul (KR); Beumjin CHO, Seoul (KR)

(73) Assignee: SAMSUNG SDS CO., LTD., Seoul (KR)

(21) Appl. No.: 19/198,259

(22) Filed: May 5, 2025

(30) Foreign Application Priority Data
May 7, 2024 (KR) 10-2024-0059600
Mar. 26, 2025 (KR) 10-2025-0038922

(51) Int. Cl. H04L 9/40

(52) U.S. Cl. CPC H04L 63/20

(57) ABSTRACT

Proposed are a method, an apparatus, a system, and a computer program for security processing of a multi-agent system. More specifically, the present disclosure discloses a method for managing security for a multi-agent system by using a computing apparatus. The method includes establishing an execution plan comprising a plurality of agents to perform a request of a user on the basis of the request, executing one or more agents among the plurality of agents according to the execution plan, and providing a response to the request of the user on the basis of an execution result of the one or more agents among the plurality of agents, wherein access to or input/output of the one or more agents is controlled through a policy enforcement point that enforces a security policy for the one or more agents among the plurality of agents.

### CROSS REFERENCE TO RELATED APPLICATION

The present application claims priority to Korean Patent Applications No. 10-2024-0059600, filed May 7, 2024 and No. 10-2025-0038922, filed Mar. 26, 2025, the entire contents of which are incorporated herein for all purposes by this reference.

### BACKGROUND OF THE INVENTION

### Field of the Invention

The present disclosure relates generally to a method, an apparatus, a system, and a computer program for security processing of a multi-agent system. More particularly, the present disclosure relates to a method, an apparatus, a system, and a computer program for security processing of a multi-agent system that can enhance security through information flow and access control among a plurality of agents performing sub-tasks constituting a given task.

### Description of the Related Art

Recently, various types of online services based on wired and wireless communication networks have been continuously increasing, and in relation to this, various services using agents are being provided.

More specifically, with the recent development of artificial intelligence models such as a large language model (LLM), online services provided by combining agents on the basis of these models are rapidly spreading.

In this regard, as security issues such as exposure of personal information or corporate secrets have become prominent, the importance of security is continuously increasing, but conventional approaches have typically been limited to ensuring security by checking or authorizing or, if necessary, blocking the input and output of artificial intelligence models such as large language models (LLMs) or single agents.

However, recently, a multi-agent system has been attempted which divides a given task into several sub-tasks and has a plurality of agents perform the sub-tasks. However, the multi-agent system may have security issues that are difficult to address with security techniques for a single agent.

To give a more specific example, when a multi-agent system uses an agent A, which is designed to process sensitive information, and agent B, which is not, and when an output generated by the agent A, which may include sensitive information, is supplied as an input to agent B, the problem that the sensitive information is leaked from agent B may arise.

As described above, there is a need for a structure capable of more systematically securing the security of a multi-agent system that processes a given task by employing a plurality of agents. In addition, there is a need for an approach that allows for efficient management of the security of services based on such a multi-agent system and further enables monitoring of the security status thereof. However, an appropriate solution for addressing these issues has not yet been proposed.

### SUMMARY OF THE INVENTION

Accordingly, the present disclosure has been made keeping in mind the above problems occurring in the related art, and the present disclosure is intended to propose a method, an apparatus, a system, and a computer program for security processing of a multi-agent system that can provide a structure for more systematically securing security for a multi-agent system that processes a given task by using a plurality of agents.

In addition, the present disclosure is intended to provide a method, an apparatus, a system, and a computer program for security processing of a multi-agent system that can efficiently manage the security of a service based on the multi-agent system and monitor the status of the security, etc. More specifically, the present disclosure is intended to provide a method, an apparatus, a system, and a computer program for security processing of a multi-agent system that can effectively determine and execute security policies among agents in the multi-agent system, and further centrally manage the security policies.

The technical problems to be solved in the present disclosure are not limited to the technical problems mentioned above, and other technical problems not mentioned can be clearly understood by those skilled in the art to which the present disclosure belongs from the contents described in this specification.

In order to achieve the objectives f the present disclosure, according to a first aspect of the present disclosure, there is provided a method for managing security for a multi-agent system by using a computing apparatus, the method including: establishing an execution plan comprising a plurality of agents to perform a request of a user on the basis of the request; executing one or more agents among the plurality of agents according to the execution plan; and providing a response to the request of the user on the basis of an execution result of the one or more agents among the plurality of agents, wherein access to or input/output of the one or more agents may be controlled through a policy enforcement point that enforces a security policy for the one or more agents among the plurality of agents.

Here, the policy enforcement point may be linked to a policy decision point for determining the security policy for the one or more agents, and control the access to or the input/output of the one or more agents according to the policy determined by the policy decision point.

In addition, the policy decision point may be linked to a policy information point that provides information about the one or more agents, and determine the policy for the one or more agents by reflecting the information provided by the policy information point.

In addition, in the establishing, when a security level of a first agent among the plurality of agents is higher than a security level of a second agent executed subsequent to the first agent, the execution plan may be established so that security processing for protecting sensitive information is performed on an execution result of the first agent and then the processed execution result is input to the second agent.

In addition, the establishing may include: generating a plurality of sub-tasks corresponding to the request of the user; selecting a plurality of agents corresponding to the plurality of sub-tasks; and generating an execution plan for performing the request by considering security levels of the plurality of agents.

In addition, in the establishing, the execution plan may be established by considering permission information required to execute the plurality of agents and a security level of information processed by the plurality of agents.

In addition, in the executing, when a security level of a third agent among the plurality of agents is higher than a security level of a fourth agent executed subsequent to the third agent, security processing for protecting sensitive information may be performed on an execution result of the third agent and then the processed execution result is input to the fourth agent.

Here, in the establishing, a leader agent among the plurality of agents, which is predetermined to establish an execution plan, may establish an execution plan for performing the request.

In this case, in the executing, the leader agent may sequentially execute one or more agents among the plurality of agents according to the execution plan.

In addition, in the executing, the leader agent may receive an execution result of the first agent, perform security processing for protecting sensitive information on the received execution result, and then provide the processed execution result to the second agent.

In addition, in the providing, the leader agent may compile execution results of one or more agents among the plurality of agents and generates and provide the response to the request of the user.

In addition, according to a second aspect of the present disclosure, there is provided an apparatus for managing security for a multi-agent system comprising a processor and memory, wherein the memory comprises an instruction configured to cause the apparatus to perform a specific operation when executed by the processor, wherein the specific operation includes: establishing an execution plan comprising a plurality of agents to perform a request of a user on the basis of the request; executing one or more agents among the plurality of agents according to the execution plan; and providing a response to the request of the user on the basis of an execution result of the one or more agents among the plurality of agents, wherein access to or input/output of the one or more agents may be controlled through a policy enforcement point that enforces a security policy for the one or more agents among the plurality of agents.

Here, the policy enforcement point may be linked to a policy decision point for determining the security policy for the one or more agents, and control the access to or the input/output of the one or more agents according to the policy determined by the policy decision point.

In addition, the policy decision point may be linked to a policy information point that provides information about the one or more agents, and determine the policy for the one or more agents by reflecting the information provided by the policy information point.

In addition, in the establishing, when a security level of a first agent among the plurality of agents is higher than a security level of a second agent executed subsequent to the first agent, the execution plan may be established so that security processing for protecting sensitive information is performed on an execution result of the first agent and then the processed execution result is input to the second agent.

In addition, the establishing may include: generating a plurality of sub-tasks corresponding to the request of the user; selecting a plurality of agents corresponding to the plurality of sub-tasks; and generating an execution plan for performing the request by considering security levels of the plurality of agents.

In addition, in the establishing, the execution plan may be established by considering permission information required to execute the plurality of agents and a security level of information processed by the plurality of agents.

In addition, in the executing, when a security level of a third agent among the plurality of agents is higher than a security level of a fourth agent executed subsequent to the third agent, security processing for protecting sensitive information may be performed on an execution result of the third agent and then the processed execution result may be input to the fourth agent.

In addition, according to a third aspect of the present disclosure, there is provided a computer-readable storage medium storing instructions configured to cause an apparatus for managing security for a multi-agent system comprising a processor to implement a specific operation when executed by the processor, wherein the specific operation includes: establishing an execution plan comprising a plurality of agents to perform a request of a user on the basis of the request; executing one or more agents among the plurality of agents according to the execution plan; and providing a response to the request of the user on the basis of an execution result of the one or more agents among the plurality of agents, wherein access to or input/output of the one or more agents is controlled through a policy enforcement point that enforces a security policy for the one or more agents among the plurality of agents.

Accordingly, in the method, apparatus, system, and computer program for security processing of a multi-agent system according to an embodiment of the present disclosure, it is possible to secure more systematic security for the multi-agent system which processes a given task by using a plurality of agents.

In addition, in the method, apparatus, system, and computer program for security processing of a multi-agent system according to an embodiment of the present disclosure, it is possible to efficiently manage the security of a service based on the multi-agent system and monitor the status of the security, etc.

More specifically, in the method, apparatus, system, and computer program for security processing of a multi-agent system according to an embodiment of the present disclosure, it is possible to effectively determine and execute security policies among agents in the multi-agent system, and further centrally manage the security policies.

The effects that can be obtained from the present disclosure are not limited to the effects mentioned above, and other effects that are not mentioned can be clearly understood by those skilled in the art to which the present disclosure belongs from the contents described in this specification.

### BRIEF DESCRIPTION OF THE DRAWINGS

The accompanying drawings, which are included as part of the detailed description to aid in understanding the present disclosure, provide embodiments of the present disclosure and, together with the detailed description, describe the technical ideas of the present disclosure.

FIG. 1 is a drawing illustrating the configuration of a multi-agent security system according to an embodiment of the present disclosure;

FIG. 2 is a flowchart illustrating a multi-agent security method according to an embodiment of the present disclosure;

FIG. 3 is a drawing illustrating a multi-agent security system configured according to an embodiment of the present disclosure;

FIG. 4 is a flowchart illustrating the steps of establishing a multi-agent security method according to an embodiment of the present disclosure;

FIG. 5 is a drawing illustrating the specific configuration and operation of a multi-agent security system configured according to an embodiment of the present disclosure;

FIG. 6 is a drawing illustrating the configuration and operation of a zero trust architecture configured according to an embodiment of the present disclosure;

FIGS. 7A, 7B and 7C are drawings illustrating the specific configurations and operations of a multi-agent security system according to an embodiment of the present disclosure;

FIG. 8 illustrates pseudocode of an access policy decision algorithm in a multi-agent security system according to an embodiment of the present disclosure;

FIGS. 9 and 10 are drawings illustrating the specific configurations and operations of a multi-agent security system according to an embodiment of the present disclosure; and

FIG. 11 is a drawing illustrating the configuration of a computing apparatus performing multi-agent security according to an embodiment of the present disclosure.

### DETAILED DESCRIPTION OF THE INVENTION

Hereinafter, embodiments disclosed in the present specification will be described in detail with reference to the accompanying drawings. The purpose, specific advantages and novel features of the present disclosure will become more apparent from the following detailed description and preferred embodiments when taken in conjunction with the accompanying drawings.

Terms and words used in this specification and claims should be interpreted as meanings and concepts that are consistent with the technical idea of the present disclosure and are appropriately defined by the inventors to explain their own inventions in the best possible way, and should not be interpreted as limiting the present disclosure, but only for the purpose of explaining embodiments.

When assigning reference numerals to components, components that are identical or similar will be assigned the same reference numerals regardless of the reference numerals, and any duplicate descriptions thereof will be omitted. The terms “module” and “part” used for components in the following description are assigned or used interchangeably in consideration of the ease of writing the specification, and do not have distinct meanings or roles in themselves, and may refer to software or hardware components.

In describing the components of the present disclosure, when a component is expressed in singular form, it should be understood that the component also includes plural forms unless specifically stated otherwise. In addition, terms “first,” “second,” etc. are used to distinguish one component from another, and components are not limited by the terms. In addition, when a component is connected to another component, it means that still another component may be connected between the component and the another component.

In addition, in describing the embodiments disclosed in this specification, if it is determined that a detailed description of a related known technology may obscure the gist of the embodiments disclosed in this specification, the detailed description is omitted. In addition, the attached drawings are only intended to facilitate understanding of the embodiments disclosed in this specification, and does not limit the technical ideas disclosed in this specification, and should be understood to include all modifications, equivalents, or substitutes included in the spirit and technical scope of the present disclosure.

Next, exemplary embodiments of a method, an apparatus, system, and a computer program for security processing of a multi-agent system according to the present disclosure will be described in detail with reference to the attached drawings.

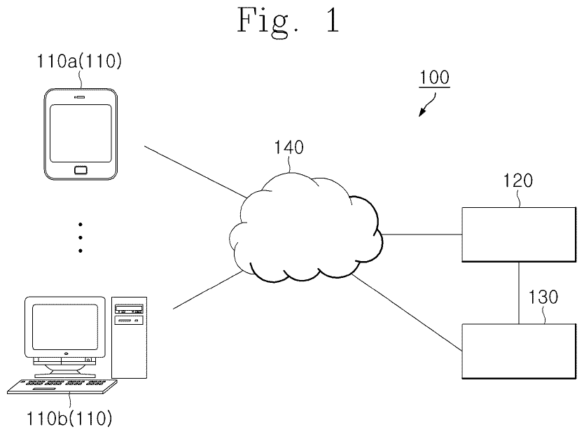

First, FIG. 1 illustrates the configuration and operation of a multi-agent security system 100 according to an embodiment of the present disclosure. As can be seen in FIG. 1, the multi-agent security system 100 according to the embodiment of the present disclosure may include one or more terminals 110, a multi-agent service apparatus 130 that provides a multi-agent-based service that is linked to the one or more terminals 110 and processes a request of a user of the terminal 110 based on a multi-agent, and a multi-agent security apparatus 120 that is capable of detecting and responding to various security issues that may occur in relation to the multi-agent.

In this case, in the present disclosure, the terminal 110 is capable of transmitting the request of a user to the multi-agent service apparatus 130, receiving a response to the request from the multi-agent service apparatus 130, and further, providing a user interface environment for performing security tasks related to the multi-agent service through the multi-agent security apparatus 120.

Here, various types of terminals such as a personal computer (PC), laptop PC, tablet PC, smartphone, or personal digital assistant (PDA) may be used as the terminal 110, but the present disclosure is not limited thereto. In addition, various devices capable of transmitting the request of a user, receiving a response to the request from the multi-agent service apparatus 130, and further providing a user interface environment for performing security tasks for the multi-agent service by using the multi-agent security apparatus 120 may also be used as the terminal 110.

In addition, each of the multi-agent security apparatus 120 and the multi-agent service apparatus 130 may be implemented by using one or more physical server devices, but, the present disclosure is not necessarily limited thereto, and further may be configured by using a cloud system, etc., or implemented in various forms, such as a dedicated apparatus.

Furthermore, in some cases, the multi-agent security apparatus 120 and the multi-agent service apparatus 130 may combined and implemented as a single apparatus or system.

In addition, as shown in FIG. 1, a communication network 140 that connects the terminal 110, the multi-agent security apparatus 120, and the multi-agent service apparatus 130 may include a wired network and a wireless network, and specifically, may include various communication networks such as a local area network (LAN), a metropolitan area network (MAN), and a wide area network (WAN). In addition, the communication network 140 may include the well-known World Wide Web (WWW). Furthermore, the communication network 140 may be implemented by using a data bus, etc. configured to transmit and receive data, etc.

In addition, FIG. 1 illustrates that the terminal 110, the multi-agent security apparatus 120, and the multi-agent service apparatus 130 are implemented separately, but the present disclosure is not necessarily limited thereto. In addition, it is possible to implement in various forms, such as a form in which two or more of the terminal 110, the multi-agent security apparatus 120, and the multi-agent service apparatus 130 are combined.

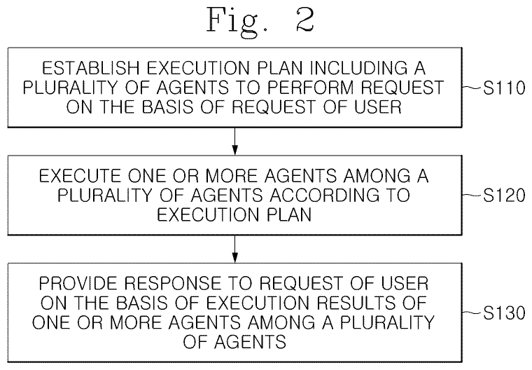

In addition, FIG. 2 illustrates a flowchart of the multi-agent security method according to an embodiment of the present disclosure.

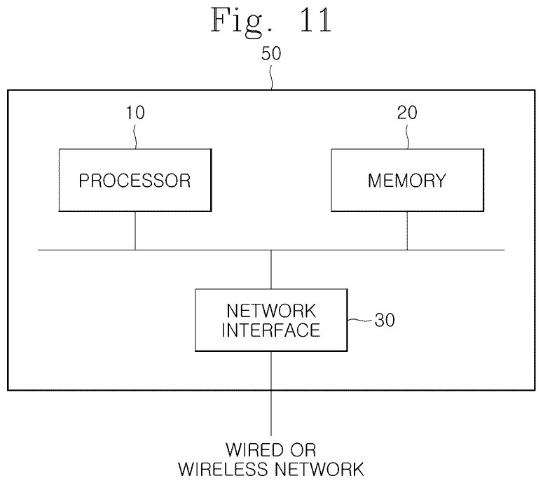

Here, the method illustrated in FIG. 2, for example, may be performed by the multi-agent security apparatus 120 of FIG. 1, and further, the multi-agent security apparatus 120 may be implemented by using a computing apparatus 50 of FIG. 11 as described later with reference to FIG. 11. For example, the multi-agent security apparatus 120 is provided with a processor 10, and the processor 10 may execute instructions configured to implement operations for performing security for the multi-agent system, such as the multi-agent service apparatus 130.

More specifically, as can be seen in FIG. 2, the multi-agent security method according to an embodiment of the present disclosure, which is a method for managing security for the multi-agent system by using the computing apparatus 50, may include establishing an execution plan including a plurality of agents to perform a request of a user on the basis of the request in S110, executing one or more agents among the plurality of agents according to the execution plan in S120, and providing a response to the request of the user on the basis of an execution result of the one or more agents among the plurality of agents in S130, wherein access to or input/output of the one or more agents may be controlled through a policy enforcement point that enforces a security policy for the one or more agents among the plurality of agents.

Here, the policy enforcement point may be linked to a policy decision point for determining the security policy for the one or more agents, and may control the access to or the input/output of the one or more agents according to the policy determined by the policy decision point.

In addition, the policy decision point may be linked to a policy information point that provides information about the one or more agents, and may determine the policy for the one or more agents by reflecting the information provided by the policy information point.

In addition, in the establishing in S110, when a security level of a first agent among the plurality of agents is higher than a security level of a second agent executed subsequent to the first agent, the execution plan may be established so that security processing for protecting sensitive information is performed on an execution result of the first agent and then the processed execution result is input to the second agent.

In addition, the establishing in S110 may include generating a plurality of sub-tasks corresponding to the request of the user in S111, selecting a plurality of agents corresponding to the plurality of sub-tasks in S112, and generating an execution plan for performing the request by considering security levels of the plurality of agents in S113.

In addition, in the establishing, the execution plan may be established by considering permission information required to execute the plurality of agents and a security level of information processed by the plurality of agents.

In addition, in the executing in S120, when a security level of a third agent among the plurality of agents is higher than a security level of a fourth agent executed subsequent to the third agent, security processing for protecting sensitive information may be performed on an execution result of the third agent and then the processed execution result may be input to the fourth agent.

Here, in the establishing in S110, a leader agent among the plurality of agents, which is predetermined to establish an execution plan, may establish an execution plan for performing the request.

In this case, in the executing in S120, the leader agent may sequentially execute one or more agents among the plurality of agents according to the execution plan.

In addition, in the executing in S120, the leader agent may receive the execution result of the first agent, perform security processing for protecting sensitive information on the received execution result, and then provide the processed execution result to the second agent.

In addition, in the providing in S130, the leader agent may compile execution results of one or more agents among the plurality of agents and generate and provide the response to the request of the user.

Accordingly, in the method, apparatus, system, and computer program for security processing of a multi-agent system according to an embodiment of the present disclosure, it is possible to secure more systematic security for the multi-agent system that processes a given task by using a plurality of agents, to efficiently manage the security of a service based on the multi-agent system and monitor the status of the security, etc., and to effectively determine and execute security policies among agents in the multi-agent system, and further centrally manage the security policies.

Hereinafter, the configurations and operations of the method, apparatus, and system for security processing of the multi-agent system according to an embodiment of the present disclosure will be described in more detail with reference to each drawing.

First, in S110, the computing apparatus 50, such as the multi-agent security apparatus 120, establishes an execution plan including a plurality of agents 230 to perform the request of a user on the basis of the request.

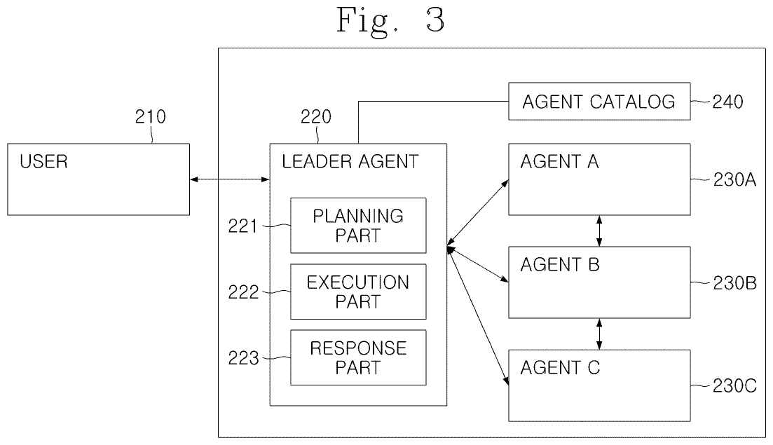

More specifically, referring to FIG. 3, when a user inputs a request for a task or query to be performed by using an endpoint 210, the endpoint 210 may transmit the request of the user to the multi-agent security apparatus 120 through the communication network 140.

Next, the multi-agent security apparatus 120 may establish an execution plan for performing the request of the user on the basis of the plurality of agents.

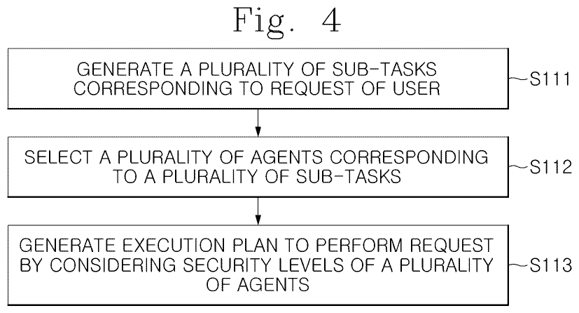

In this case, referring to FIG. 4, the establishing in S110 may include generating a plurality of sub-tasks corresponding to the request of the user in S111, selecting a plurality of agents corresponding to the plurality of sub-tasks in S112, and generating an execution plan for performing the request by considering security levels of the plurality of agents in S113.

For a more specific example, the multi-agent security apparatus 120 may provide artificial intelligence (AI) application services, etc. on the basis of the multi-agent system (MAS), and in this case, may configure and service application by using a plurality of agents, such as a leader agent 220 and the remaining agents 230 as can be seen in FIG. 3.

In this case, the leader agent 220 may divide a task requested by a user into a plurality of sub-tasks, select agents 230 suitable for executing each of the sub-tasks by using an agent catalog 240, etc., and then determine an execution order between each of the agents 230 to establish a task plan for executing the task according to the request of the user.

Accordingly, the leader agent 220 of the multi-agent security apparatus 120 may execute the task plan, compiles the execution results of the agents 230, and provide the resulting results to the user through the endpoint 210, etc.

More specifically, in S110, the leader agent 220, which is predetermined to establish an execution plan among the plurality of agents, may establish an execution plan for performing the request.

However, the present disclosure is not necessarily limited to this, and it is possible to implement the execution plan establishment function performed by the leader agent 220 in various forms, such as the execution plan establishment function being distributed across the plurality of agents 230 to be performed.

In addition, in the present disclosure, an appropriate user interface, etc. may be adopted between the leader agent 220 and the endpoint 210 of a user.

Next, in S120, one or more agents 230 among the plurality of agents are executed according to the execution plan established in the computing apparatus 50, such as the multi-agent security apparatus 120.

However, when the request of a user is performed on the basis of multi-agents, new security issues in relation to the flow of information between agents and access control may arise.

For a more specific example, when a task according to a request of a user, such as a prompt entered by the user, is processed on the basis of the multi-agent system, the multi-agent system divides the task according to the request of the user into a plurality of sub-tasks, establishes an execution plan including an order and input/output relationship among each of the sub-tasks, and then assigns agents 230 corresponding to each of the sub-tasks to execute the task according to the order of the execution plan. In this case, the output of each of the agents 230 may be directly/indirectly supplied as an input to a subsequent agent 230.

Accordingly, when, among the agents 230 included in the execution plan, there are an agent A (230A) designed to process sensitive information requiring security and an agent B (230B) that is not designed to process such information, if a result produced by the agent A (230A) (i.e., an output that may include sensitive information) is supplied as an input to the agent B (230B), the problem that the sensitive information is leaked by the agent B (230B) that does not recognize the sensitive information may occur.

In this regard, the present disclosure allows for determining or applying an access policy for each agent by considering information handled between the agent A (230A) and the agent B (230B) and the security levels of the agent A (230A) and the agent B (230B), and further monitoring the status of policy application, thereby enabling more efficient and systematic security of the multi-agent system.

More specifically, in S120, when the security level of the first agent among the plurality of agents is higher than the security level of the second agent executed subsequent to the first agent, it is possible to perform security processing (e.g., block processing, etc.) for protecting sensitive information on the execution result of the first agent and then input the processed execution result to the second agent.

In addition, even in S120, it is possible for the leader agent 220 to sequentially execute the one or more agents 230 among the plurality of agents according to the execution plan to produce a result.

Accordingly, the leader agent 220 may receive the execution result of the first agent, perform security processing (e.g., block processing) for protecting sensitive information on the received execution result, and then provide the processed execution result to the second agent.

Next, in S130, the computing apparatus 50, such as the multi-agent security apparatus 120, provides a response to the request of the user on the basis of the execution results of the one or more agents 230 among the plurality of agents.

More specifically, even in S130, the leader agent 220 may compile the execution results of the one or more agents 230 among the plurality of agents, generate a response to the request of the user, and then transmit the response to the endpoint 210, etc. to provide the response to the user.

More specifically, the specific configuration and operation of the agent catalog 240 and the leader agent 220 in FIG. 3 are as follows.

1. The agent catalog 240: Capable of holding and providing information on each agent 230 registered in the multi-agent system (MAS). Information that may be stored in the agent catalog 240 is as follows.
A. Name/identification information (ID) of an agent
B. Information about tasks that an agent can perform
C. Information about input and output formats of an agent
D. Other information that a leader agent needs to utilize each agent

2. A planning part 221 of the leader agent 220: Capable of dividing a task requested by a user into a plurality of sub-tasks, retrieving information about agents 230 by using the agent catalog 240, deriving a list of agents suitable for performing each of the sub-tasks, determining the execution order of each of the sub-tasks, and determining the execution order of the corresponding agent 230 to establish an execution plan.

3. An execution part 222 of the leader agent 220: Capable of calling each of the agents 230 according to the execution order of the execution plan established in the planning part 221 to execute sub-tasks.

In this case, the execution of the sub-tasks may be implemented in various ways, either logically or physically, and may include one or more of the following two types, for more specific examples.

A. A centralized type: The execution part 222 of the leader agent 220 delegates the execution/calling of all agents 230. For example, when the flow of data between actual agents (230) is performed from the agent A (230A) to the agent B (230B), the execution part 222 transmits sub-tasks to the agent A (230A), and in this case, the agent A (230A) returns the execution result to the execution part 222. Accordingly, the execution part 222 may be driven in such a manner that the execution result returned by the agent A (230A) is transferred to the agent B (230B), and then the agent B (230B) returns the execution result back to the execution part 222.

B. A decentralized type: The execution part 222 of the leader agent 220 transmits sub-tasks to an agent 230 corresponding to the first step of an overall execution plan, and receives a result from an agent 230 corresponding to the last step, so that, for example, the execution part 222 does not get involved in execution between the agent 230 of the first step and the agent 230 of the last step. For a more specific example, when the flow of data between actual agents 230 is performed from the agent A (230A) to the agent B (230B), the execution part 222 may be driven in such a manner that when sub-tasks are transmitted to the agent A (230A), the agent A (230A) directly transmits the execution result to the agent B (230B), and then the agent B (230B) returns the execution result to the execution part 222.

4. A response part 223 of the leader agent 220: When the execution part 222 completes the execution of sub-tasks according to an execution plan established by the planning part 221, the response part 223 receives the results, processes a response according to the request of a user, and returns the response to the endpoint 210 so as to provide the response to the user.

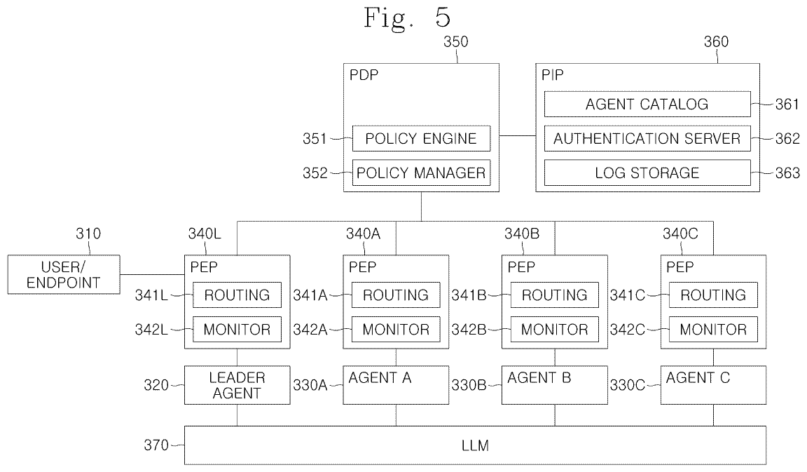

In this regard, FIG. 5 illustrates the specific configuration and operation of the multi-agent security system according to an embodiment of the present disclosure.

Referring to FIG. 5, the computing apparatus 50, such as the multi-agent security apparatus 120, may control access to or input/output of one or more agents 230 through a policy enforcement point (PEP) 340 that enforces a security policy on the one or more agents 230 among the plurality of agents.

Here, the policy enforcement point 340 may be linked to a policy decision point (PDP) 350 for determining a security policy for the one or more agents 330, and may control access to or input/output of the one or more agents 330 according to a policy determined by the policy decision point 350.

In addition, the policy decision point 350 may be linked to a policy information point (PIP) 360 that provides information about the one or more agents 330, and may determine a policy for the one or more agents 330 by reflecting the information provided by the policy information point 360.

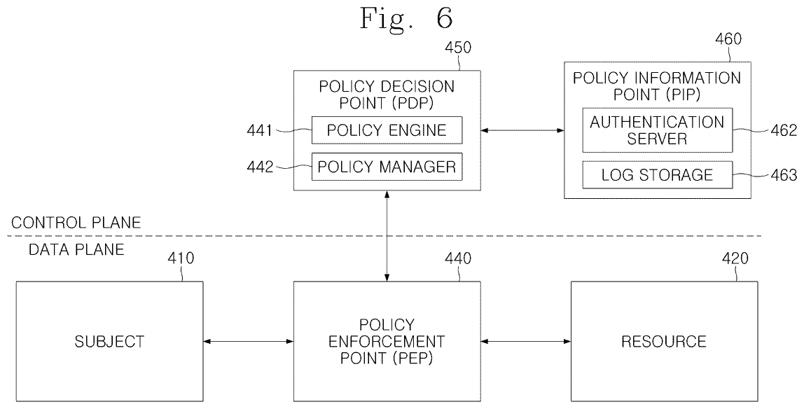

In this regard, FIG. 6 illustrates a drawing describing the specific operations of the policy enforcement point 340, the policy decision point 350, and the policy information point 360.

More specifically, referring to FIG. 6, first, a resource 420, which is a resource to be protected or provided, may vary depending on a system to which the resource is applied, but may generally include a database, a server, service, a business system, etc.

In addition, a subject 410, which is a subject that intends to use the resource 420, may generally include a user, a client program, a terminal, etc., and further, in the present disclosure, may include the leader agent 220, an agent 230, etc.

Accordingly, a policy decision point 450 may function to determine and distribute an access policy of the subject 410 for the resource 420.

More specifically, a policy engine 441 of the policy decision point 450 may make a final decision on granting access to the resource 420 requested by the subject 410. Accordingly, the policy engine 441 may make a decision on allowing or denying access to the resource 420, or canceling access already allowed, and may further store the decision details as log information.

Next, a policy manager 442 of the policy decision point 450 may send an instruction to establish or terminate a session between the subject 410 and the resource 420 to a policy enforcement point 440, thereby executing the policy decision of the policy engine 441, and further generate a session-specific authentication/authorization token and credentials that the subject 410 uses to access the resource 420.

Accordingly, the policy enforcement point 440 may perform the role of establishing, monitoring, and terminating a connection between the subject 410 and the resource 420. Accordingly, the policy enforcement point 440 may provide the function of processing an access request or downloading a policy from the policy manager 442 while communicating with the policy manager 442.

Next, a policy information point 460 may function to record and maintain information necessary for the security of the multi-agent system (e.g., information about authentication of the subject 410 and the resource 420, a list of the resource 420 that may be provided, status information of the resource 420, logs, etc.).

More specifically, an authentication server 462 of the policy information point 460 may perform authentication and authorization for the subject 410 or the resource 420, and may function to store and manage information required for this.

In addition, a log storage 463 of the policy information point 460 may record and manage the operation status of the policy enforcement point 440 and the resource 420 (e.g., access permission/blocking history, error occurrence, etc.).

Here, a policy may be a decision made by the policy decision point 450, and more specifically, a decision as to whether or not to allow access requested through the policy enforcement point 440 between the subject 410 and the resource 420.

More specifically, the following are examples of information that may be considered at the policy decision point 450 when determining a policy.

1. An access control method regarding which subject 410 may access the resource 420 under what conditions.

2. An authentication method regarding how to verify the identity of the subject 410, such as a user or device.

3. An authorization method regarding how to confirm the authority of the subject 410.

4. A session management method regarding connection duration, a re-authentication cycle, encryption requirements, etc. between the subject 410 and the resource 420.

5. A routing method for a connection path between the subject 410 and the resource 420.

6. Logging and monitoring methods regarding what activities the policy enforcement point 440 should record and monitor.

In this case, the policy enforcement point 440, the policy decision point 450, and the policy information point 460 may, as a basic principle, not trust all types of access and allow access to the resource 420 after explicit trust confirmation.

To this end, consistent and centralized policy management and access control decisions and execution are required, and detailed access control such as management and strong authentication of users and devices, and granting of least privilege through classification and management of the resource 420, creation of logical boundaries and session-based access permissions, application of communication protection technology, monitoring of all states, logs and continuous verification of reliability through these, and control, etc. may be applied.

More specifically, referring to FIG. 5, an endpoint 310 of a user may correspond to the subject 410 of FIG. 6, and the leader agent 320 and other agents 330 may correspond to the resource 420, and further, when access is made from one agent 320 or 330 to another agent 320 or 330, the agent 320 or 330 that requested the access may correspond to the subject 410.

Accordingly, the policy enforcement point 340 may perform the role of allowing/blocking communication/access between the endpoint 310 or an agent 320 or 330 and another agent 320 or 330. More specifically, when access is requested, the policy enforcement point 340 may provide the identity of the endpoint 310 or agent 320 or 330, which requested the access, and information about the agent 320 or 330, to which access is requested, to the policy decision point 350 and receive a decision on whether to allow the access request.

Furthermore, in the present disclosure, when determining a policy on whether to grant access, the policy decision point 350 may perform a policy decision by considering the specificity of the multi-agent system, and for a more specific example, may determine the policy by considering whether authority of the endpoint 310 or agent 320 or 330 that requested the access matches authority required by the agent 320 or 330 to which access was requested (e.g., write access to a personnel system, read access to a financial system, etc.).

In addition, as another example, it is also possible to determine a policy by considering whether the security level of information handled by an endpoint 310 or agent 320 or 330 requesting access is higher than the security level of information handled by an agent 320 or 330 to which access is requested. Here, a higher security level means that more sensitive information can be handled, and accordingly, an output generated from the endpoint 310 or agent 320 or 330 with a high security level may include sensitive information. Therefore, when the output is input from the endpoint 310 or agent 320 or 330 with a high security level to the agent 320 or 330 with a low security level without appropriate security measures, there may be the risk that the agent 320 or 330 with a low security level may not properly manage sensitive information and may expose or inappropriately process the information. In the present disclosure, it is possible to collect information required for the policy decision (the authority or security level of the endpoint 310 or agent 320 or 330) through information registered in an agent catalog 361 or an authentication server 362 and reflect the information in the policy decision.

More specifically, each component will be described with reference to FIG. 5 below.

1. The endpoint 310 of a user: The user may request a task to be performed by using the endpoint 310 or receive the result of performing the task and provide the result to the user.

2. The leader agent 320: Configured to receive information about a task requested by a user, such as a prompt entered by a user, convert the task into a plurality of sub-tasks, establish and execute an execution plan for performing the task, and transmit the result of performing the task to the endpoint 310 to provide the result to the user.

More specifically, as can be seen in FIG. 3, the leader agent 320 may be provided with the planning part 221, the execution part 222, and the response part 223.

Here, the planning part 221 receives information about a task requested by a user, such as a prompt of a user, divides the task into sub-tasks that can be executed by agents 330 registered in the agent catalog 361, and establishes an execution plan including execution orders and data flow for the sub-tasks.

In this case, when a user does not have permission required to run the agent 320 or 330 or fails to configure all the agents 320 and 330 required to process the request of the user, the request may be judged as unexecutable and the execution of the task request of the user may be stopped.

More specifically, in the planning part 221, it is possible to process the prompt of a user by using a neural network model 370 such as a large-scale language model (LLM) or a neural network model-based service to interpret the prompt of a user and divide the prompt into sub-tasks.

In this case, in the planning part 221, information about permission required to execute an agent 320 or 330 is obtained from the agent catalog 361, and whether a user has corresponding permission may be confirmed through the authentication server 362.

In addition, in the planning part 221, a plan may be established to prevent information from flowing from an agent 320 or 330 with a high security level to an agent 320 or 330 with a low security level by considering the security levels of the agents 320 and 330, and when it is difficult to avoid this, it is possible to establish an execution plan so that information can be transmitted through a sensitive information filter, etc.

Next, in the execution part 222, the agents 320 and 330 may be executed according to the execution plan generated in the planning part 221. In this case, filtering of sensitive information, etc. may be performed on information flowing between the agents 320 and 330 according to the execution plan, and then, when an execution termination condition is satisfied (for example, when the execution of all agents 320 and 330 is completed according to the execution plan, or when the execution result of an agent 320 or 330 designated as the last agent 320 or 330 is received, etc.), the compiling of the task execution results is performed.

Accordingly, in the response part 223, a response to the request of a user may be generated on the basis of the task execution results compiled in the execution part 222 and transmitted to the endpoint 310 to be provided to the user.

3. The policy enforcement point (PEP) 340: Configured to control access to the endpoint 310 of a user or another agent 320 or 330 requested by an agent 320 or 330, and to apply security policies such as message encryption policies.

More specifically, when the endpoint 310 of a user or an agent 320 or 330) requests access to another agent 320 or 330, the policy enforcement point 340 may request the policy decision point 350 to decide whether to allow access according to the request, and may allow or block the access on the basis of the decision of the policy decision point 350.

In this case, the policy enforcement point 340 may provide the policy decision point 350 with information necessary for making a decision (e.g., information about the identity of a user, information about a connected endpoint 310, identification information of an agent 320 or 330 requesting access, identification information of an agent 320 or 330 to which access is requested, details of the request of a user, etc.).

In addition, the policy enforcement point 340 may be provided with a routing block 341 for controlling traffic for information transmission and a monitor block 342 for securing operation observability. The functions of each are as follows.

More specifically, the routing block 341 may perform a function of blocking or permitting communication between agents 320 and 330 according to the decision of the policy decision point 350 and, when the communication is permitted, may transmit the result of the task of the agent 330 performed in the current step to the leader agent 320 or another agent 330 to be performed in the next step.

In addition, the monitor block 342 may monitor the operating status of each agent 320 or 330 and periodically transmit log information to the policy information point 360.

4. The policy decision point (PDP) 350: The policy decision point 350 receives an access policy decision requested from the policy enforcement point 340 in the process of executing an agent 320 or 330 according to the established execution plan, and determines in real time whether to permit access and performs a function to command the policy enforcement point 340 to execute it. In this case, at the policy decision point 350, the policy decision may be determined by considering permission held by a user requesting access, the security level of an agent 320 or 330 requesting access, permission and security level required by an agent 320 or 330 to which access is requested, a requested task, etc.

In this case, the policy enforcement point 340 may provide the policy decision point 350 with information necessary for making a decision (e.g., information about the identity of a about endpoint 310, user, information a connected identification information of an agent 320 or 330 requesting access, identification information of an agent 320 or 330 to which access is requested, details of request of a user, etc.), and the policy decision point 350 may determine a policy by considering the information provided by the policy enforcement point 340 and information provided by the agent catalog 361 and the authentication server 362.

More specifically, the policy enforcement point 340 may be provided with a policy engine 351 and a policy manager 352.

In this case, the policy engine 351 may allow or restrict access to agents 320 and 330, and further, may determine a policy to cancel already allowed access (session). Furthermore, the policy engine 351 may be composed of one or more engines according to decision logic.

For a more specific example, the policy engine 351 may restrict the flow of information from a high-level agent (e.g., an agent handling sensitive information) to a low-level agent by checking the security levels of an access requester and an access request target from the perspective of limiting the leakage of sensitive information.

In addition, for another example, when an agent 320 or 330 to which access is requested needs access to a personnel database to perform a task, access to the corresponding agent 320 or 330 may be blocked if a user requesting the task does not have access to the personnel database.

In addition, the policy manager 352 may generate an instruction to execute an access policy for an agent 320 or 330 according to a decision made by the policy engine 351 and transmit the instruction to the policy enforcement point 340 to execute the function of enforcing the policy.

5. An agent 320 or 330: In order to perform a task according to the request of a user, the agent receives and executes sub-tasks, etc. and returns the result. In this case, the agent 320 or 330 may perform communication for transmitting the input information and result, etc. through the policy enforcement point 340.

6. The policy information point (PIP) 360: Configured to manage and provide information about each agent 320 or 330 and a user used in the multi-agent system (MAS).

In this case, the policy information point 360 may be provided with the agent catalog 361, the authentication server 362, and a log storage 363.

In this case, the agent catalog 361 may manage the list and information of agents 320 and 330 registered in the multi-agent system (MAS). For example, the agent catalog 361 may include the following information.
i. Names of agents 320 and 330
ii. Description of tasks which the agents 320 and 330 perform
iii. Description of input and output formats of the agents 320 and 330
iv. System permissions required for the agents 320 and 330 to perform tasks (e.g., access/read/write to each database, web search, etc.)
v. Security levels of the agents 320 and 330: Whether input/output may include sensitive information or what sensitive information may be handled, etc.

Next, the authentication server 362 may manage information about a user authorized in the multi-agent system (MAS), provide services such as user authentication and permission management, and for this purpose, store and manage information necessary for authenticating a user and information about access permission of each user (e.g., permissions to access/read/write each database, a permission to web search, etc.).

In addition, the log storage 363 may store and manage monitoring information about security and status collected from the policy enforcement point 340, thereby providing security observability.

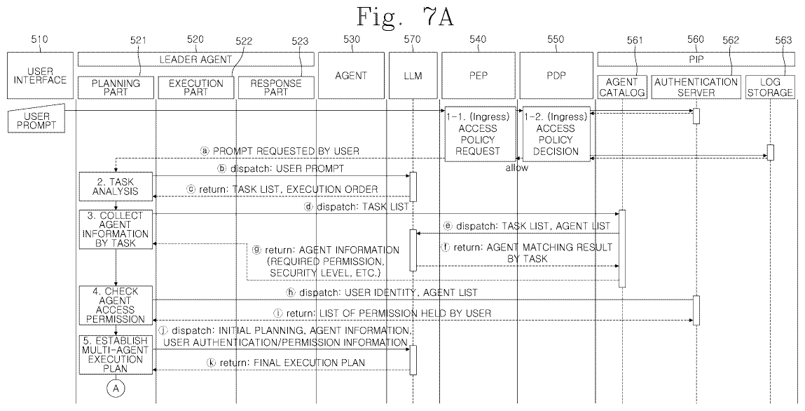

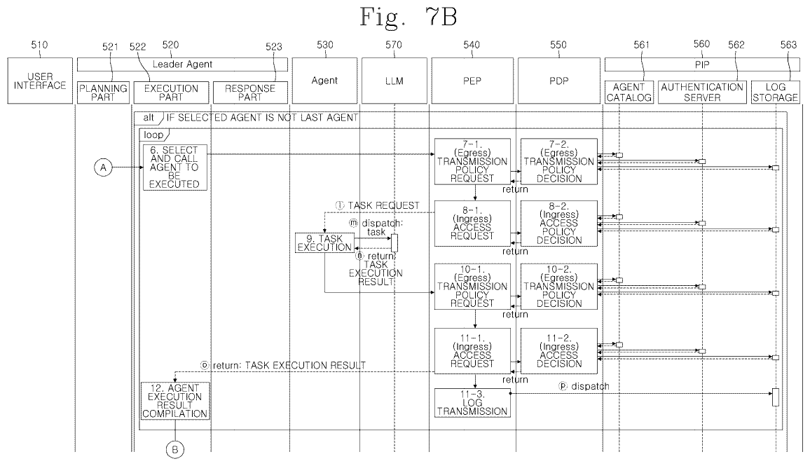

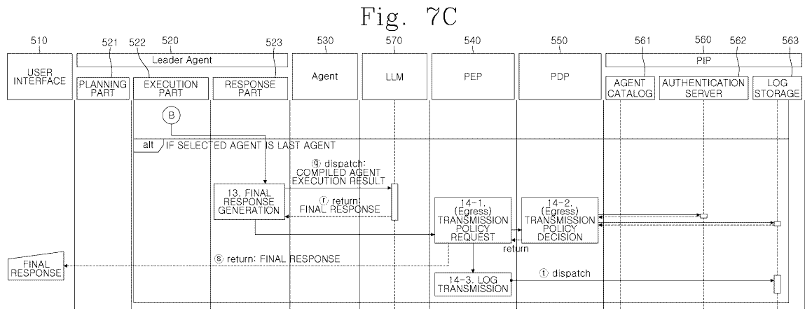

More specifically, FIGS. 7A, 7B and 7C illustrate the specific configurations and operations of the multi-agent security method and system according to an embodiment of the present disclosure.

Hereinafter, the multi-agent security method and system according to the embodiment of the present invention will be described in more detail with reference to FIGS. 7A, 7B and 7C.

First, when a user inputs a request, such as a prompt, through a user interface (UI) 510, a policy enforcement point (PEP) 540 of a leader agent 520 that receives the request of the user intercepts the request of the user (\textcircled{a} of FIG. 7A), and then transmits user information, such as the identity and access terminal of the user, to a policy decision point (PDP) 550 to request a policy on whether to allow access (1-1 of FIG. 7A).

Accordingly, the policy decision point (PDP) 550 uses an authentication server 562 to check authentication status of a user and an access permission to resources, and the policy engine makes a decision to allow or deny access to the user, and then returns the result to the policy enforcement point 540 of the leader agent 520 (1-2 of FIG. 7A).

In this case, when the access of the user is permitted, the policy enforcement point 540 of the leader agent 520 transmits the request of the user (\textcircled{a} of FIG. 7A) such as a prompt to a planning part 521 of the leader agent 520.

On the other hand, when the access of the user is denied, the policy enforcement point 540 of the leader agent 520 may output an access restriction message through the user interface (UI) 510 and record a log related to the access denial in a log storage 563.

Next, the planning part 521 of the leader agent 520, which receives the user request, such as a prompt, from the policy enforcement point 540 of the leader agent 520, transmits the user request, such as a prompt, to a neural network model 570, such as a large-scale language model (LLM) (\textcircled{b} of FIG. 7A), and receives, from the neural network model 570, initial execution plan (\textcircled{c} of FIG. 7A) including a list of sub-tasks that can be executed by agents 530 in response to the user request, and an execution order (2 of FIG. 7A).

Next, the planning part 521 may request a list of agents 330 that can be executed in response to the sub-tasks from an agent catalog 561 of a policy information point 560 (\textcircled{d} of FIG. 7A).

Accordingly, the agent catalog 561 may find an agent 530 matching each sub-task by using a large-scale language model 570, etc. (\textcircled{e}, \textcircled{f} of FIG. 7A), and return, to the planning part 521 (\textcircled{g} of FIG. 7A), information on permission information required to execute each agent 530 and information about the security level of information processed by the agent 530 (3 of FIG. 7A).

Next, the planning part 521 may provide the identity of a user, a list of agents 530, etc. to the authentication server 562 and may confirm the list of permissions held by the user for each agent 530 (\textcircled{h}, \textcircled{i} of FIG. 7A) (4 of FIG. 7A).

In addition, in the planning part 521, the information of the collected agents 530 and the permission information of the user is provided to the large-scale language model 570, etc., so that a final execution plan based on multi-agents can be established and provided (\textcircled{j}, \textcircled{k} of FIG. 7A) (5 of FIG. 7A).

Furthermore, in a case in which information flows from agent A to the agent B, when agent A is an agent that processes sensitive information and the agent B is an agent that does not process sensitive information, it is also possible to establish an execution plan such that after sensitive information of the execution result of agent A is removed while the execution result passes through the leader agent, the execution result is transmitted to the agent B.

Next, referring to FIGS. 7B AND 7C, on the basis of the final execution plan generated in the planning part 521, an agent 530 to be executed in an execution part 522 is selected and requested to perform a corresponding sub-task (6 of FIG. 7B).

Accordingly, when a corresponding sub-unit task is requested for the agent 530 selected in the execution part 522, the policy enforcement point 540 of the leader agent 520 intercepts the task request data and requests the policy decision point 550 to determine whether the task request from the leader agent 520 to the selected agent 530 is permitted (7-1 of FIG. 7B).

In this regard, the policy decision point 550 receives a transmission policy decision request from the policy enforcement point 540 of the leader agent 520, checks information about required permissions, security levels, input/output formats, etc. of the leader agent 520 and the selected agent 530 from the agent catalog 561, collects user authentication and permission information from the authentication server 562, checks anomaly detection information, etc. from the log storage 563, and then determines whether to allow transmission on the basis of this, and transmits the result to the policy enforcement point 540 of the leader agent 520 (7-2 of FIG. 7B).

In this case, when transmission is permitted, the task request is transmitted from the policy enforcement point 540 of the leader agent 520 to the policy enforcement point 540 of the selected agent 530.

On the other hand, when transmission is rejected, a task stop message may be transmitted through a user interface 510 and related log information may be recorded.

Next, when the task request transmission from the leader agent 520 to the selected agent 530 is permitted, the task request is transmitted from the policy enforcement point 540 of the leader agent 520 to the policy enforcement point 540 of the selected agent 530. In this case, traffic may be safely transmitted through an encrypted channel, and the policy enforcement point 540 of the agent 530 that received the task request requests an access policy to the policy decision point 550 (8-1 of FIG. 7B).

Accordingly, the policy decision point 550, which receives the access policy request, queries the policy information point 560 for the task type, user permission information for related resources, etc. to determine whether to grant permission, and transmits the decision result to the policy enforcement point 540 of the agent 530 (8-2 of FIG. 7B).

In this case, when access is permitted, the policy enforcement point 540 of an agent 530 provides the task request received from the policy enforcement point 540 of the leader agent 520 to the agent 530 (\textcircled{1} of FIG. 7B).

On the other hand, when access is denied, a task stop message may be delivered through the user interface 510, and related log information may be recorded.

Next, the agent 530 may receive the task request and perform the task by using the neural network model 570, such as a large-scale language model (\textcircled{m}, \textcircled{n} of FIG. 7B) (9 of FIG. 7B).

Accordingly, when the task execution is completed in the agent 530, the policy enforcement point 540 of the agent 520 requests the policy decision point 550 to make a policy decision on whether to allow transmission in order to transmit the task execution result to the leader agent 520 that requested the task (10-1 of FIG. 7B).

Accordingly, the policy decision point 550, which receives the transmission policy decision request from the policy enforcement point 540 of the agent 520, uses information collected from the agent catalog 561 and the authentication server 562 to determine whether to allow transmission and provides the decision to the policy enforcement point 540 (10-2 of FIG. 7B).

In this case, when transmission is permitted, the result of the task execution is transmitted from the policy enforcement point 540 of the agent 530 to the policy enforcement point 540 of the leader agent 520.

On the other hand, when transmission is rejected, a task stop message may be transmitted through the user interface 510 and related log information may be recorded.

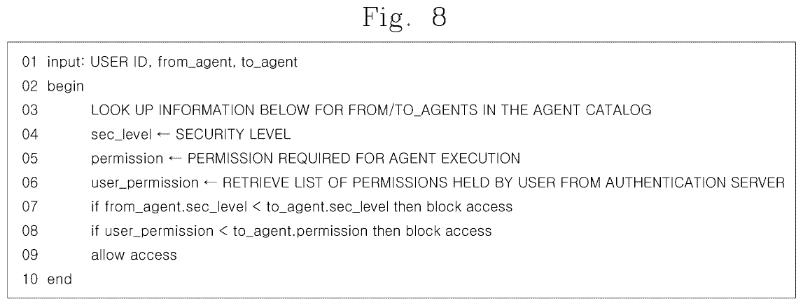

For a more specific example, FIG. 8 illustrates an algorithm for determining a policy on whether to allow access in the policy decision point 550.

Referring to FIG. 8, the policy decision point 550 receives information about a user identification (ID), a transfer request agent (from_agent), and a transfer target agent (to_agent) (01 of FIG. 8), and then searches the agent catalog 561 for information about the transfer request agent (from_agent) and the transfer target agent (to_agent), such as security levels, permissions required to execute an agent, and a list of permissions held by a user (02-06 of FIG. 8). When the security level of the transfer request agent is lower than the security level of the transfer target agent, the policy decision point 550 blocks access (07 of FIG. 8). In addition, when permissions of the user are lower than permissions required to execute the agent, the policy decision point 550 blocks access (08 of FIG. 8), and otherwise, permits access (09-10 of FIG. 8).

Next, when the policy enforcement point 540 of the agent 530 receives permission from the policy decision point 550 to transmit the task execution result, the policy enforcement point 540 of the agent 530 transmits the task execution result to the policy enforcement point 540 of the leader agent 520 that requested the task, and the policy enforcement point 540 of the leader agent 520 that received the task execution result requests the policy decision point 550 for whether to allow access to the leader agent 520 (11-1 of FIG. 7B).

Accordingly, the policy decision point 550 uses the policy information point 560 to check information such as the security level and input/output format of an agent 530, which transmits the task execution result, as well as user authentication and permission information to determine whether to permit access, and transmits the determined policy to the policy enforcement point 540 of the leader agent 520 (11-2 of FIG. 7B).

In this case, the policy enforcement point 540 of the leader agent 520, which has received an access permission decision from the policy decision point 550, may transmit the task execution result received from the policy enforcement point 540 of the agent 530 to the execution part 522 of the leader agent 520 (\textcircled{o} of FIG. 7B) and record the related information in the log storage 563. On the other hand, when access permission is denied, a task stop message may be transmitted through the user interface 510 and related log information may be recorded (\textcircled{p} of FIG. 7B) (11-3 of FIG. 7B).

Accordingly, the execution part 522 receives the task execution result from the policy enforcement point 540 of the leader agent 520 and compiles the task execution result of each agent 530 (12 of FIG. 7B).

In this case, when the agent 530 that performed the task is not the last agent 530 according to the execution plan established in the planning part 521, steps 6 to 12 of FIG. 7B are repeated and executed (the loop of FIG. 7B).

On the other hand, when the agent 530 that performed the task is the last agent 530 according to the execution plan established in the planning part 521, the execution part 522 of the leader agent 520 transmits the compiled task execution result of each agent 530 to a response part 523, and accordingly, the response part 523 generates a final response to a user request, such as a user prompt, by using the neural network model 570, such as a large-scale language model (LLM) (\textcircled{q}, \textcircled{r} of FIG. 7C) (13 of FIG. 7C).

Next, the policy enforcement point 540 of the leader agent 520 intercepts a request to transmit the final response to the user interface 510, and requests the policy decision point 550 to make a policy decision on whether to allow transmission of the request (14-1 of FIG. 7C).

Next, the policy decision point 550 collects the authentication status of a user from the authentication server 562 and security threat detection information from the log storage 563 to determine whether to allow transmission thereof and transmits the result to the policy enforcement point 540 of the leader agent 520 (14-2 of FIG. 7C).

Accordingly, the policy enforcement point 540 of the leader agent 520 may transmit the final response through the user interface 510 (\textcircled{s} of FIG. 7C), while, in the case of receiving a transmission rejection decision, a response rejection message may be transmitted through the user interface 510 and related log information may be recorded (\textcircled{t} of FIG. 7C) (14-3 of FIG. 7C).

Accordingly, the present disclosure provides a centralized structure capable of determining a security policy between agents 520 and 530 in the multi-agent system (for example, allowing/blocking access between agents, encryption level of communication section between agents, etc.) through the policy decision point 550 and the policy information point 560. Furthermore, the present disclosure provides a structure capable of executing the security policy between the agents 520 and 530 in the multi-agent system through the policy enforcement point 540, and capable of centrally managing this through the policy decision point 550 and the policy information point 560.

In addition, the present disclosure provides easy implementation of security observability for communication between agents 520 and 530 in the multi-agent system by collecting information through the policy enforcement point 540 and compiling and managing the information by using the policy information point 560.

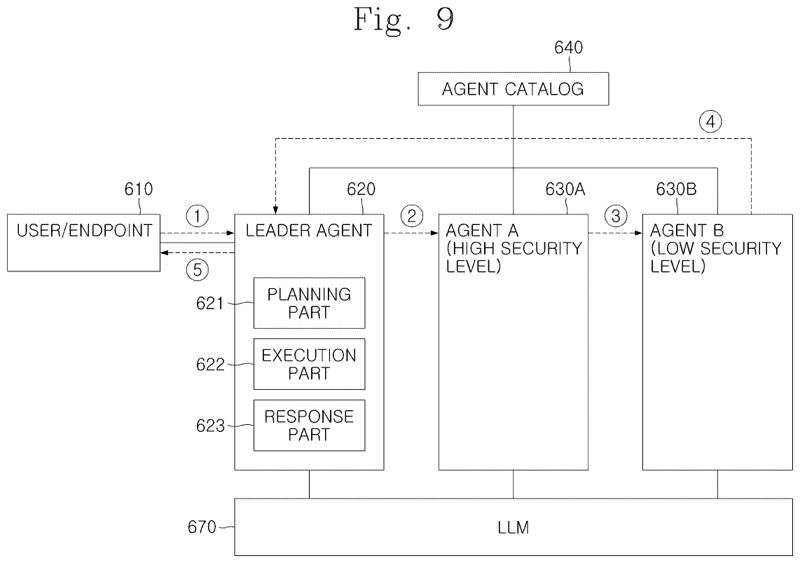

In this regard, FIG. 9 illustrates a case in which sensitive information is at risk of being leaked due to failure to consider the security level of an agent 630 while establishing an execution plan in the multi-agent system (MAS).

More specifically, as can be seen in FIG. 9, a user request, such as a prompt input through an endpoint 610, may be transmitted to a leader agent 620 (\textcircled{1} of FIG. 9), and the leader agent 620 may analyze the user request to derive a plurality of sub-tasks, and then may select an agent A (630A) and an agent B (630B) suitable for the sub-tasks among agents registered in an agent catalog 640.

In this case, when the leader agent 620 establishes an execution plan without considering the security levels of the agent A (630A) and the agent B (630B), the leader agent 620 may establish the execution plan so that information flows from the agent A (630A) with a high security level to the agent B (630B) with a low security level.

Accordingly, the leader agent 620 may transmits the first sub-task to the first agent, the agent A (630A), according to the established execution plan so that the agent A (630A) executes the first sub-task (\textcircled{2} of FIG. 9), and then, when the agent A (630A) completes the sub-task, transfer the task result to agent B (630B) so that the second sub-task according to the execution plan is executed (\textcircled{3} of FIG. 9).

Next, the agent B (630B) returns the task result to the leader agent 620 (\textcircled{4} of FIG. 9).

Accordingly, The leader agent 620 may compile the execution results of the sub-tasks, generate a response to a user request, and then provide the response to a user through the endpoint 610 (\textcircled{5} of FIG. 9).

However, since the agent A (630A) is an agent that has a high security level and handles sensitive information, there is a possibility that a task result that agent B (630B) receives from the agent A (630A) may also contain sensitive information, and since agent B (630B) is an agent that has a low security level and does not properly handle sensitive information, there is a possibility that sensitive information may be leaked during the process of performing sub-tasks (for example, sensitive information may be leaked through email transmission or web search, etc.).

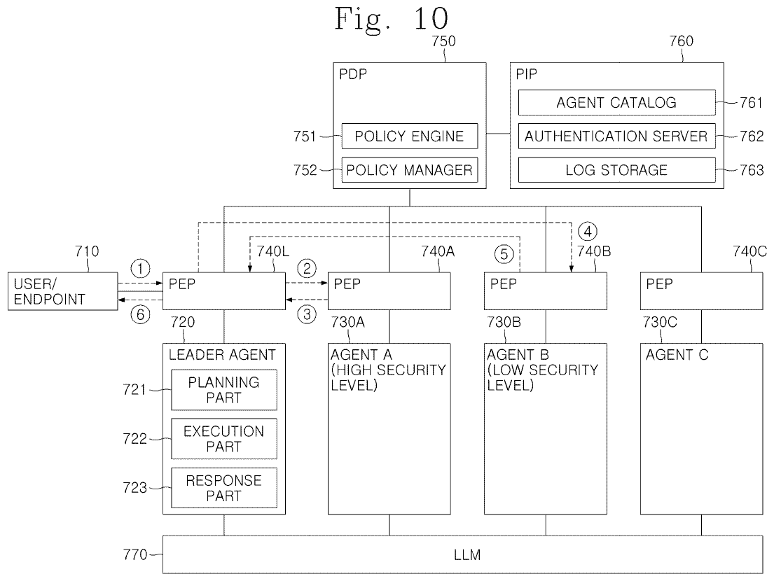

In this regard, FIG. 10 illustrates a case in which an execution plan is established by considering the security level of an agent 730 in the multi-agent system (MAS) according to the present disclosure to prevent leakage of sensitive information.

More specifically, as can be seen in FIG. 10, when a user requests a task through a terminal such as an endpoint 710, a policy enforcement point 740L of a leader agent 720 first transmits information such as identity of the user and the connected terminal to a policy decision point 750 to verify access permission of the user.

In this case, when the permission of the user is confirmed, the leader agent 720 analyzes the task requested by the user, divides the task into sub-tasks, and establishes an execution plan.

More specifically, a task requested by a user may be analyzed by a planning part 721 of the leader agent 720 and divided into a plurality of sequential sub-tasks, and then the planning part 721 may select an agent A (730A) and agent B (730B) suitable for the divided sub-tasks among agents registered in the agent catalog 761.

In this case, in the planning part 721, on the basis of the information of the agent A (730A) and agent B (730B) registered in the agent catalog 761, it may be determined that the agent A (730A) is an agent with a high security level that can handle sensitive information, while agent B (730B) is an agent with a low security level that cannot properly handle sensitive information.

Accordingly, since direct information transmission from the agent A (730A) with a high security level to agent B (730B) with a low security level may cause a risk of leakage of sensitive information, the planning part 721 may establish an execution plan so that when the agent A (730A) transmits a task execution result to agent B (730B), the task execution result is required to be transmitted to agent B (730B) after the leader agent 720 removes sensitive information from the task execution result when the task execution result goes through the leader agent 720.

In addition, a policy enforcement point 740 of each agent 720 or 730 may receive a decision on whether to allow access by transmitting information about the identity of a user, a connected terminal, an agent which requested task execution, and an agent, to which task execution was requested, to the policy decision point 750 when the leader agent 720 requests the agent A (730A) to perform the first sub-task according to the execution plan, or when the agent A (730A) subsequently requests agent B (730B) to perform the second sub-task according to the execution plan via the leader agent 720.

In this case, when deciding whether to allow access, policy decision point 750 may comprehensively consider the permission of a user, the security levels and permissions of an agent requesting a task and an agent requested to perform the task to determine whether to allow access.

More specifically, referring to FIG. 10, first, when a user requests a task through a terminal such as the endpoint 710, the policy enforcement point 740L of the leader agent 720 receives the task request from the user (\textcircled{1} of FIG. 10), and requests authentication and authorization for the user to the policy decision point 750.

Accordingly, when not approved, the user request may be blocked, whereas when the user request is approved, the planning part 721 of the leader agent 720 divides the task request of the user into a plurality of sub-tasks and establishes an execution plan.

In this case, the leader agent 720 may check the security levels of the agent A (730A) and agent B (730B) that will perform each sub-task, and establish an execution plan to prevent direct information transmission from the agent A (730A) with a high security level to agent B (730B) with a low security level.

More specifically, the leader agent 720 may establish an execution plan so that the task execution result of the agent A (730A) goes through the leader agent 720 to perform security processing for protecting sensitive information and then is transmitted to agent B (730B).

Accordingly, the leader agent 720 requests the agent A (730A), which is the first agent according to the execution plan, to perform the first sub-task (\textcircled{2} of FIG. 10).

Next, the policy enforcement point 740A of the agent A (730A) transmits information about the identity of a user, a connected terminal, the leader agent 720 which requested task execution, and the agent A (730A), to which task execution was requested, to the policy decision point 750, and receives a decision on whether or not to allow access.

In this case, when access is permitted, the agent A (730A) performs a given sub-task, and transmits the result to the leader agent 720 instead of transmitting the result directly to an agent B (730B) (\textcircled{3} of FIG. 10).

Accordingly, the policy enforcement point 740L of the leader agent 720 transmits information about the identity of a user, the connected terminal, the agent A (730A) requesting the task execution, and the agent B (730B), to which the task execution was requested, to the policy decision point 750, and receives a decision on whether to allow access.

In this case, when access is permitted, the leader agent 720 removes sensitive information from the task execution result of the agent A (730A) and processes the task execution result into sub-tasks to be transmitted to the agent B (730B) (\textcircled{4} of FIG. 10).

Accordingly, a policy enforcement point 740B of the agent B (730B) transmits information about the identity of a user, a connected terminal, the agent A (730A) which requested task execution, and the agent B (730B), to which task execution was requested, to the policy decision point 750, and receives a decision on whether to allow access. When access is permitted, the agent B (730B) performs a given sub-task and returns the task execution result to the leader agent 720 (5 of FIG. 10).

Accordingly, the policy enforcement point 740L of the leader agent 720 transmits information about the identity of a user, a connected terminal, the agent B (730B) which requested task execution, and the agent B (730B), to which task execution was requested, to the policy decision point 750, and receives a decision on whether to allow access. When access is permitted, the leader agent 720 may compile task execution results, create a response to the request of a user, and then provide the response to the user (\textcircled{6} of FIG. 10).

More specifically, in the present disclosure, the policy decision point (PDP) may classify security levels according to the characteristics of information handled by each agent, and control policy decision and information flow on the basis of the security levels. Furthermore, in addition to deciding whether to block or allow access, it is also possible to decide and apply a processing method for sensitive information (e.g., filtering and conversion, etc.).

In addition, t disclosure, the policy information point (PIP) not only manages information about users, devices, and network conditions, but also manages profiles based on the characteristics of information handled by each agent and the sensitivity of information that can be output. Furthermore, the policy information point (PIP) may automatically analyze agents on the basis of the neural network model to create profiles, or allow an administrator to manually input profiles for the agents.

In addition, in the present disclosure, the policy enforcement point (PEP) may not only block or allow access, but also safely process transmitted information before transmitting it.

Accordingly, in the method, apparatus, system, and computer program for security processing of a multi-agent system according to an embodiment of the present disclosure, it is possible to more systematically secure security for the multi-agent system that processes a given task by using a plurality of agents, to efficiently manage the security of services based on the multi-agent system, to monitor security status, to effectively decide and execute security policies between agents in the multi-agent system, and further to centrally manage them.

In addition, according to another aspect of the present disclosure, a computer program is characterized by being a computer program stored on a computer-readable medium for executing a series of steps of the multi-agent security method discussed above on a computer. The computer program may be a computer program that includes machine language codes generated by a compiler, as well as a computer program that includes high-level language codes that can be executed on a computer by using an interpreter, etc. In this case, the computer is not limited to a personal computer (PC) or a laptop computer, and includes any information processing device equipped with a central processing unit (CPU) that can execute a computer program, such as a server, smartphone, tablet PC, PDA, or mobile phone.

In addition, a computer-readable medium may be a medium that permanently stores a computer-executable program or temporarily stores the computer-executable program for execution or downloading. In addition, the medium may be various recording or storage means in the form of a single hardware device or a combination of a plurality of hardware components, and is not limited to media directly connected to a specific computer system, but may also be distributed across a network. Accordingly, the above detailed description should not be construed as restrictive in all respects but should be considered illustrative. The scope of the present disclosure should be determined by a reasonable interpretation of the appended claims, and all changes within the equivalent scope of the present disclosure are included within the scope of the present disclosure.

In addition, a multi-agent security apparatus according to an embodiment of the present disclosure is an apparatus for managing security a multi-agent system including a processor and memory, wherein the memory includes an instruction configured to cause the apparatus to perform a specific operation when executed by the processor, wherein the specific operation includes: establishing an execution plan comprising a plurality of agents to perform a request of a user on the basis of the request; executing one or more agents among the plurality of agents according to the execution plan; and providing a response to the request of the user on the basis of an execution result of the one or more agents among the plurality of agents, wherein access to or input/output of the one or more agents may be controlled through a policy enforcement point that enforces a security policy for the one or more agents among the plurality of agents.

Here, the policy enforcement point may be linked to a policy decision point for determining the security policy for the one or more agents, and may control the access to or the input/output of the one or more agents according to the policy determined by the policy decision point.

In addition, the policy decision point may be linked to a policy information point that provides information about the one or more agents, and may determine the policy for the one or more agents by reflecting the information provided by the policy information point.

In addition, in the establishing, when a security level of a first agent among the plurality of agents is higher than a security level of a second agent executed subsequent to the first agent, the execution plan may be established so that security processing for protecting sensitive information is performed on an execution result of the first agent and then the processed execution result is input to the second agent.

In addition, the establishing may include generating a plurality of sub-tasks corresponding to the request of the user; selecting a plurality of agents corresponding to the plurality of sub-tasks; and generating an execution plan for performing the request by considering security levels of the plurality of agents.

In addition, in the establishing, the execution plan may be established by considering permission information required to execute the plurality of agents and a security level of information processed by the plurality of agents.

In addition, in the executing, when a security level of a third agent among the plurality of agents is higher than a security level of a fourth agent executed subsequent to the third agent, security processing for protecting sensitive information may be performed on an execution result of the third agent and then the processed execution result may be input to the fourth agent.

In addition, FIG. 11 illustrates the device 50 to which the proposed method of the present disclosure can be applied.

Referring to FIG. 11, the device 50 may be configured to implement a multi-agent security process according to the proposed method of the present disclosure.

For example, the device 50 to which the proposed method of the present disclosure may be applied may include network devices such as repeaters, hubs, bridges, switches, routers, and gateways, computer devices such as desktop computers and workstations, mobile terminals such as smartphones, portable devices such as laptop computers, home appliances such as digital TVs, and transportation means such as automobiles. As another example, the device 50 to which the present disclosure may be applied may be included as part of an application specific integrated circuit (ASIC) implemented in the form of a System On Chip (SoC).

Memory 20 may be connected to the processor 10 when in operation, and may store programs and/or instructions for processing and controlling the processor 10, and may store data and information used in the present disclosure, control information required for processing data and information according to the present disclosure, temporary data generated during data and information processing, etc. The memory 20 may be implemented as a storage device such as a Read Only Memory (ROM), Random Access Memory (RAM), Erasable Programmable Read Only Memory (EPROM), Electrically Erasable Programmable Read Only Memory (EEPROM), flash memory, Static Random Access Memory (SRAM), Hard Disk Drive (HDD), Solid State Drive (SSD), or the like.

The processor 10 may be operatively connected to the memory 20 and/or a network interface 30 and controls the operation of each module within the device 50. In particular, the processor 10 may perform various control functions for performing the proposed method of the present disclosure. The processor 10 may also be referred to as a controller, a microcontroller, a microprocessor, a microcomputer, etc. The proposed method of the present disclosure may be implemented by hardware, firmware, software, or a combination thereof. When the present disclosure is implemented by using hardware, an application specific integrated circuit (ASIC), a digital signal processor (DSP), a digital signal processing device (DSPD), a programmable logic device (PLD), a field programmable gate array (FPGA), or the like, configured to perform the present disclosure, may be included in the processor 10. Meanwhile, when implementing the proposed method of the present disclosure by using firmware or software, the firmware or software may include instructions related to modules, procedures or functions that perform functions or operations necessary for implementing the proposed method of the present disclosure, and the instructions may be stored in the memory 20 or stored in a computer-readable recording medium (not shown) separate from the memory 20 and, when executed by the processor 10, may be configured to cause the device 50 to implement the proposed method of the present disclosure.

In addition, the device 50 may include a network interface device 30. The network interface device 30 is operatively connected to the processor 10, and the processor 10 may control the network interface device 30 to transmit or receive wireless/wired signals carrying information and/or data, signals, messages, etc. through a wireless/wired network. The network interface device 30 supports various communication standards such as IEEE 802 series, 3GPP LTE(-A), 3GPP 5G, etc., and may transmit and receive control information and/or data signals according to the communication standards. The network interface device 30 may be implemented outside the device 50 as needed.

The above embodiments and drawings described in this specification are merely illustrative and do not limit the scope of the present disclosure in any way. In addition, connection between lines or connection members between the components illustrated in the drawings are merely illustrative of functional connections and/or physical or circuit connections, and may be replaced or represented as various additional functional connections, physical connections, or circuit connections in an actual device. In addition, when there is no specific mention such as “essential,” “important,” etc., a component may not be absolutely necessary for the application of the present disclosure.

The use of the terms “above” and similar referential terms in the specification of the present disclosure (especially in the claims) may refer to both the singular and the plural. In addition, when a range is described in the present disclosure, it is considered to include an invention that apply individual values falling within the range (unless otherwise stated), and is equivalent to describing each individual value constituting the range in the detailed description of the invention. In addition, the steps presented in the method invention in the present disclosure are not necessarily intended to be bound by their chronological order, and the order may be appropriately changed as needed, unless a certain step must come first depending on the nature of each process. The use of any examples or exemplary terms (e.g., “for example,” “etc.”) in the present disclosure is intended merely to elaborate the present disclosure and does not limit the scope of the present disclosure by virtue of such examples or exemplary terms, unless otherwise limited by the claims. In addition, those skilled in the art will appreciate that various modifications, combinations and variations may be made according to design conditions and elements within the scope of the appended claims or their equivalents.

What is claimed is:

1. A method for managing security for a multi-agent system by using a computing apparatus, the method comprising:
establishing an execution plan comprising a plurality of agents to perform a request of a user on the basis of the request;
executing one or more agents among the plurality of agents according to the execution plan; and
providing a response to the request of the user on the basis of an execution result of the one or more agents among the plurality of agents,
wherein access to or input/output of the one or more agents is controlled through a policy enforcement point that enforces a security policy for the one or more agents among the plurality of agents.

2. The method of claim 1, wherein the policy enforcement point is linked to a policy decision point for determining the security policy for the one or more agents, and controls the access to or the input/output of the one or more agents according to the policy determined by the policy decision point.

3. The method of claim 2, wherein the policy decision point is linked to a policy information point that provides information about the one or more agents, and determines the policy for the one or more agents by reflecting the information provided by the policy information point.

4. The method of claim 1, wherein in the establishing, when a security level of a first agent among the plurality of agents is higher than a security level of a second agent executed subsequent to the first agent, the execution plan is established so that security processing for protecting sensitive information is performed on an execution result of the first agent and then the processed execution result is input to the second agent.

5. The method of claim 1, wherein the establishing comprises:
generating a plurality of sub-tasks corresponding to the request of the user;
selecting a plurality of agents corresponding to the plurality of sub-tasks; and
generating an execution plan for performing the request by considering security levels of the plurality of agents.

6. The method of claim 1, wherein in the establishing, the execution plan is established by considering permission information required to execute the plurality of agents and a security level of information processed by the plurality of agents.

7. The method of claim 1, wherein in the executing, when a security level of a third agent among the plurality of agents is higher than a security level of a fourth agent executed subsequent to the third agent, security processing for protecting sensitive information is performed on an execution result of the third agent and then the processed execution result is input to the fourth agent.

8. The method of claim 1, wherein in the establishing, a leader agent among the plurality of agents, which is predetermined to establish an execution plan, establishes an execution plan for performing the request.

9. The method of claim 8, wherein in the executing, the leader agent sequentially executes one or more agents among the plurality of agents according to the execution plan.

10. The method of claim 8, wherein in the executing, the leader agent receives an execution result of a first agent, performs security processing for protecting sensitive information on the received execution result, and then provides the processed execution result to a second agent.

11. The method of claim 8, wherein in the providing, the leader agent compiles execution results of one or more agents among the plurality of agents and generates and provides the response to the request of the user.

12. An apparatus for managing security for a multi-agent system comprising a processor and memory, wherein the memory comprises an instruction configured to cause the apparatus to perform a specific operation when executed by the processor, wherein the specific operation comprises:
establishing an execution plan comprising a plurality of agents to perform a request of a user on the basis of the request;
executing one or more agents among the plurality of agents according to the execution plan; and
providing a response to the request of the user on the basis of an execution result of the one or more agents among the plurality of agents,
wherein access to or input/output of the one or more agents is controlled through a policy enforcement point that enforces a security policy for the one or more agents among the plurality of agents.

13. The apparatus of claim 12, wherein the policy enforcement point is linked to a policy decision point for determining the security policy for the one or more agents, and controls the access to or the input/output of the one or more agents according to the policy determined by the policy decision point.

14. The apparatus of claim 13, wherein the policy decision point is linked to a policy information point that provides information about the one or more agents, and determines the policy for the one or more agents by reflecting the information provided by the policy information point.

15. The apparatus of claim 12, wherein in the establishing, when a security level of a first agent among the plurality of agents is higher than a security level of a second agent executed subsequent to the first agent, the execution plan is established so that security processing for protecting sensitive information is performed on an execution result of the first agent and then the processed execution result is input to the second agent.

16. The apparatus of claim 12, wherein the establishing comprises:
generating a plurality of sub-tasks corresponding to the request of the user;
selecting a plurality of agents corresponding to the plurality of sub-tasks; and
generating an execution plan for performing the request by considering security levels of the plurality of agents.

17. The apparatus of claim 12, wherein in the establishing, the execution plan is established by considering permission information required to execute the plurality of agents and a security level of information processed by the plurality of agents.

18. The apparatus of claim 12, wherein in the executing, when a security level of a third agent among the plurality of agents is higher than a security level of a fourth agent executed subsequent to the third agent, security processing for protecting sensitive information is performed on an execution result of the third agent and then the processed execution result is input to the fourth agent.

19. A computer-readable storage medium storing instructions configured to cause an apparatus for managing security for a multi-agent system comprising a processor to implement a specific operation when executed by the processor, wherein the specific operation comprises:
establishing an execution plan comprising a plurality of agents to perform a request of a user on the basis of the request;
executing one or more agents among the plurality of agents according to the execution plan; and
providing a response to the request of the user on the basis of an execution result of the one or more agents among the plurality of agents,
wherein access to or input/output of the one or more agents is controlled through a policy enforcement point that enforces a security policy for the one or more agents among the plurality of agents.
